(19) United States
(12) Patent Application Publication
(10) Pub. No.: US 2016/0225511 A1
(43) Pub. Date: Aug. 4, 2016

(54) POWER INDUCTOR

(71) Applicant: SAMSUNG ELECTRO-MECHANICS CO., LTD., Suwon-si (KR)

(72) Inventors: Jong Sik YOON, Suwon-si (KR); Hiroyuki MATSUMOTO, Suwon-si (KR); Jung Wook SEO, Suwon-si (KR); Seong Jae LEE, Suwon-si (KR)

(21) Appl. No.: 15/011,166

(22) Filed: Jan. 29, 2016

(30) Foreign Application Priority Data
Jan. 30, 2015 (KR) 10-2015-0015298

(51) Int. Cl. H01F 27/245; H01F 1/147; H01F 27/29; H01F 1/20; H01F 27/28; H01F 27/02

(52) U.S. Cl. CPC H01F 27/245; H01F 27/2823; H01F 27/022; H01F 27/29; H01F 1/20; H01F 1/14708; H01F 1/14766

(57) ABSTRACT

A power inductor includes a magnetic body; a coil provided in the magnetic body; and external electrodes formed at opposite end portions of the magnetic body. The magnetic body includes a stacked plurality of magnetic sheets including a flake alloy powder, and a major axis of the flake alloy powder and a major axis of the coil are arranged in a direction parallel to an upper surface of the magnetic body.

### CROSS-REFERENCE TO RELATED APPLICATION

This application claims the benefit of priority to Korean Patent Application No. 10-2015-0015298, filed on Jan. 30, 2015 with the Korean Intellectual Property Office, the entirety of which is incorporated herein by reference.

### TECHNICAL FIELD

The present disclosure relates to a power inductor.

### BACKGROUND

An inductor is one of the important passive elements which form an electronic circuit along with a resistor and a capacitor, and is used as a component for removing noise or forming an LC resonant circuit.

An inductor may be classified into a wound-type, a multilayer-type, a thin film-type, and the like, depending on its structure, and is generally manufactured by printing a conductive pattern on an insulation layer to form a coil, which is stacked into a plurality of layers and then subjected to pressing and sintering.

Recently, as the manufacturing of miniaturized and high-performance electronic devices has been developed, essential electronic components mounted in electronic devices further require higher frequency and higher current, along with miniaturization.

Among such structures, a thin film-type inductor may be formed of a material having a high saturation magnetization value, and even in the case of being manufactured in a compact size, it may be easy to form an internal circuit pattern as compared with a multilayer-type inductor. Therefore, recently, research into thin film-type inductors has been actively conducted.

### SUMMARY

An aspect of the present disclosure provides a power conductor having a novel structure capable of property improvement.

Since it is difficult to further satisfy the properties of the inductor to be miniaturized and have a high degree of inductance due to its material limitation or structural limitation, the aspect of the power inductor according to the present disclosure was devised in order to overcome the material and structural limitations.

For this, the present disclosure provides a power inductor capable of utilizing shape anisotropy possessed by flake alloy powder.

According to an aspect of the present disclosure, a power inductor comprises: a magnetic body; a coil provided in the magnetic body; and external electrodes disposed on the magnetic body. The magnetic body comprises a stacked plurality of magnetic sheets including a flake alloy powder, and a major axis of the flake alloy powder and a major axis of the coil are arranged in a direction parallel to an upper surface of the magnetic body.

The major axis of the flake alloy powder maybe parallel to a direction of a magnetic flux generated in the coil.

The coil may include: a first wiring pattern formed in an upper magnetic sheet among the plurality of magnetic sheets, a second wiring pattern formed in a lower magnetic sheet among the plurality of magnetic sheets, a plurality of layers of vias formed in a plurality of magnetic sheets among the plurality of magnetic sheets, and electrically connecting the first and second wiring patterns, and lead patterns formed in the lower magnetic sheet, and connected to the external electrodes.

The lead patterns may be formed on a same plane as the second wiring pattern.

At least anyone of the vias, the first and second wiring patterns, and the lead patterns may include a plated layer.

The flake alloy powder may include iron (Fe).

The flake alloy powder may be one or more selected from the group consisting of an Fe—Si-based alloy, sendust (Fe—Si—Al), permalloy (Fe—Ni), an Fe—Si—Cr-based alloy, and an Fe—Si—B—Cr-based amorphous alloy.

The magnetic sheet may have a thickness of 30 μm to 90 μm.

The magnetic body may include an outer magnetic sheet provided on an outermost layer, the outer magnetic sheet covering the coil and having no pattern.

The magnetic sheet may include a binder.

The external electrodes may be formed at opposite end portions of the magnetic body.

According to another aspect of the present disclosure, a power inductor comprises : a magnetic body comprising a stacked plurality of magnetic sheets; a coil provided in the magnetic body; and external electrodes disposed on the magnetic body. The coil includes a plurality of layers of vias, the plurality of layers of vias comprising vias formed in each magnetic sheet into a plurality of layers.

According to another aspect of the present disclosure, a power inductor comprises: a magnetic body; a coil provided in the magnetic body; and external electrodes disposed on the magnetic body. The magnetic body comprises a stacked plurality of magnetic sheets, and uppermost and lowermost magnetic sheets among the plurality of magnetic sheets include a flake alloy powder, and a major axis of the flake alloy powder and a major axis of the coil are arranged in a direction parallel to an upper surface of the magnetic body.

### BRIEF DESCRIPTION OF THE DRAWINGS

The above and other aspects, features, and advantages of the present disclosure will be more clearly understood from the following detailed description taken in conjunction with the accompanying drawings, in which:

FIG. 1 is a perspective view of a power inductor according to an exemplary embodiment in the present disclosure;

FIG. 2 is a cross-sectional view taken along line I-I′ of FIG. 1;

FIG. 3 is a cross-sectional view of a magnetic sheet used in the power inductor of the present disclosure;

FIG. 4 is a partially exploded perspective view of a magnetic body of FIG. 1;

FIG. 5 is an enlarged perspective view of a coil formed within the magnetic body of FIG. 1; and

FIG. 6 is a cross-sectional view of a power inductor according to another exemplary embodiment in the present disclosure.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “upper,” or “above” other elements would then be oriented “lower,” or “below” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, embodiments of the present inventive concept should not be construed as being limited to the particular shapes of regions shown herein, for example, to include a change in shape results in manufacturing. The following embodiments may also be constituted by one or a combination thereof.

The contents of the present inventive concept described below may have a variety of configurations and propose only a required configuration herein, but are not limited thereto.

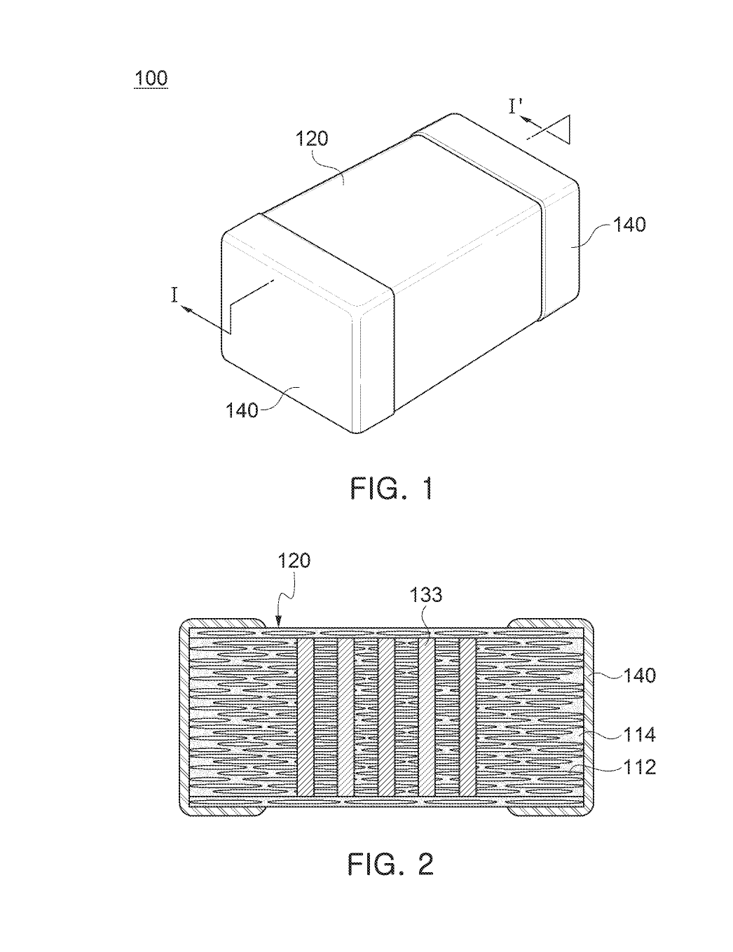

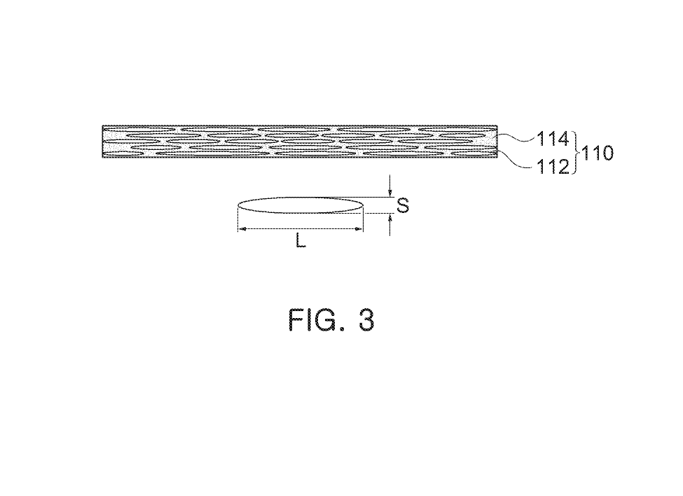

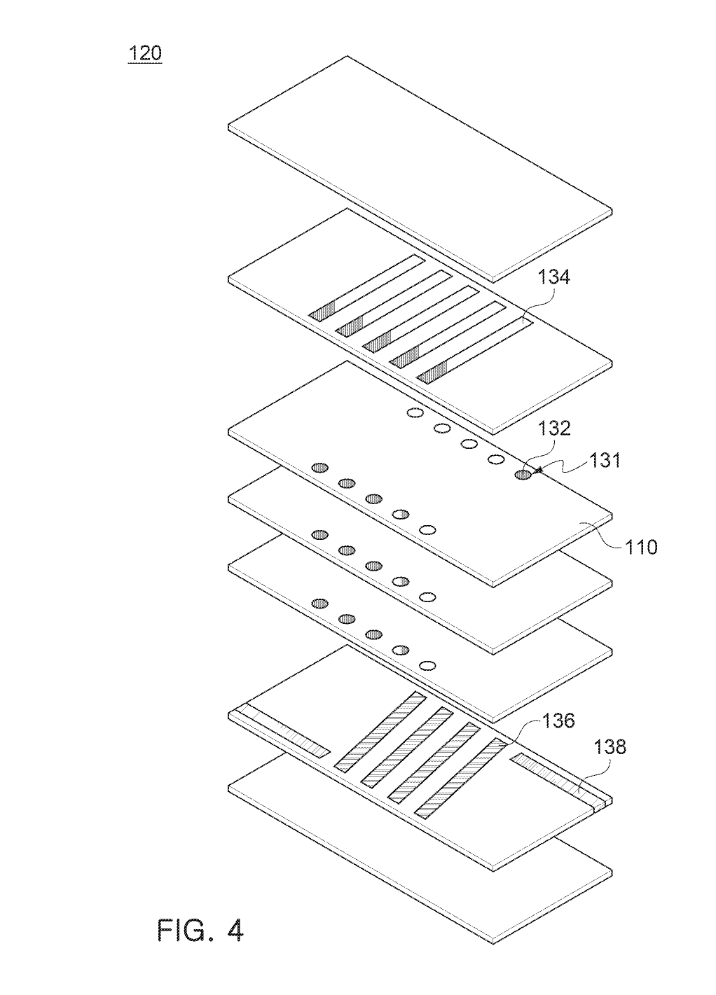

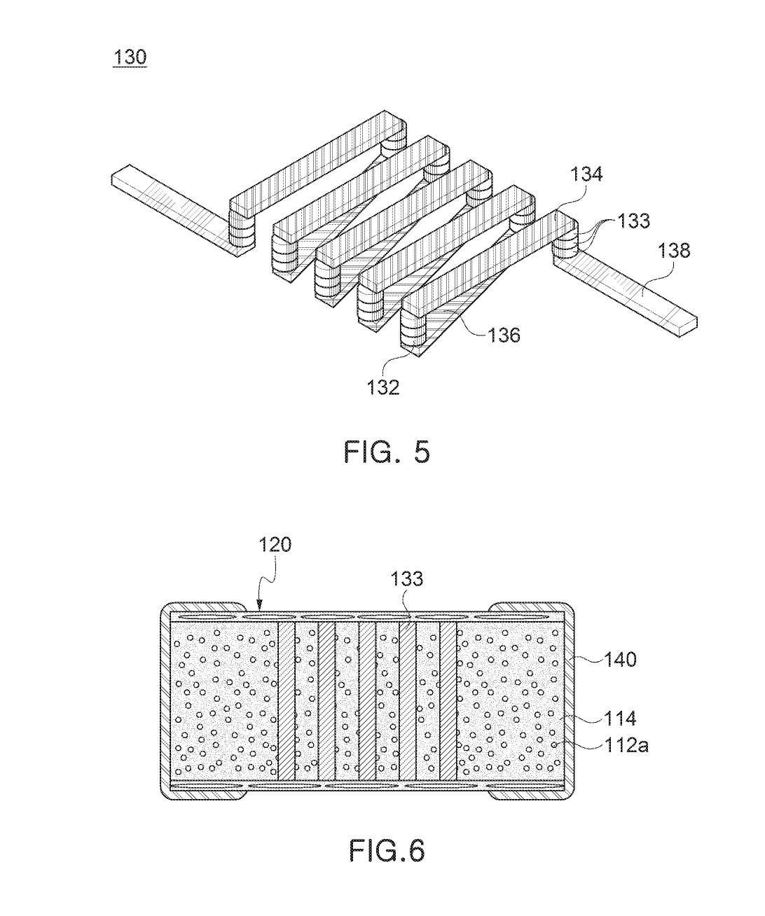

FIG. 1 is a perspective view of a power inductor according to an exemplary embodiment, FIG. 2 is a cross-sectional view taken along line I-I′ of FIG. 1, FIG. 3 is a cross-sectional view of a magnetic sheet used in the power inductor of the present disclosure, FIG. 4 is a partially exploded perspective view of a magnetic body of FIG. 1, and FIG. 5 is an enlarged perspective view of a coil formed within the magnetic body of FIG. 1.

As illustrated in FIGS. 1 to 5, the power inductor 100 of the exemplary embodiment includes a magnetic body 120, a coil 130 provided in the magnetic body 120, and external electrodes 140 formed at opposite end portions of the magnetic body 120.

Referring to FIGS. 2 and 3, the magnetic body 120 may be manufactured by stacking and then pressing a plurality of plate magnetic sheets 110 formed of magnetic materials. In FIG. 2, the magnetic body 120 is illustrated integrally without distinction of each magnetic sheet 110 in an area in which the coil (see 130 in FIG. 5) is formed, except for the magnetic sheet disposed at an outermost layer.

First, referring to FIG. 3, each magnetic sheet 110 used in the exemplary embodiment and forming the magnetic body 120 is formed by filling a binder 114 with flake alloy powder 112.

This flake alloy powder 112 is shape anisotropic powder having a major axis L and a minor axis S, and the major axis L of the flake alloy powder may be arranged in a direction parallel to an upper surface of the magnetic sheet 110.

The flake alloy powder 112 may be formed by including magnetic metal powder having little reduction in inductance by magnetic saturation, and an excellent direct current bias characteristic, such as iron (Fe).

Since magnetic metal materials generally have a relatively high saturation magnetization value (Ms) and small magnetic flux density variation depending on DC-bias, and thus represent small reduction in inductance depending on DC-bias, they are easily usable even at a high current.

The flake alloy powder 112 may be formed of an Fe—Si-based alloy, sendust (Fe—Si—Al), permalloy (Fe—Ni), an Fe—Si—Cr-based alloy, an Fe—Si—B—Cr-based amorphous alloy, and the like. Among them, one selected therefrom may be used alone, or a mixture of two or more selected therefrom may be used.

In order to utilize a large amount of the flake alloy powder 112, the binder 114 is filled with the flake alloy powder 112. As the binder 114, any known material may be employed without limitation, and for example, a resin component such as an epoxy resin may be employed.

A content ratio of the flake alloy powder 112 in each magnetic sheet 110 may be varied with inductance by frequency and a Q (quality factor) property of a chip, and a content of about 70 wt % to 98 wt % based on a total weight of the magnetic sheet 110 may be employed in view of high frequency and a high degree of inductance.

When the content of the flake alloy powder 112 is less than 70 wt %, the content of a magnetic body is too small, and thus it may be difficult to implement a high degree of inductance, whereas when the content of the flake alloy powder 112 is more than 98 wt %, eddy-current loss may be increased in a high frequency area, and sheet molding may be difficult due to a lack of content of the resin.

Further, as the thickness of each magnetic sheet 110 is reduced, the effect of increasing a density of the flake alloy powder 112 within the inductor after stacking may be generated. The increase in the density of the flake alloy powder 112 in the magnetic sheet 110 may improve the properties of the inductor, such as magnetic permeability, DC-bias property, and the like.

In this regard, it is preferred that the magnetic sheet 110 has a thickness of about 30 μm to 90 μm. Herein, when the magnetic sheet 110 has a thickness less than 30 μm, magnetic flux saturation may occur due to an excessive increase in metal density, whereas when the magnetic sheet 110 has a thickness of more than 90 μm, the inductance of the inductor may be decreased due to the decrease in packing density, and moldability may be deteriorated due to the thickening of the sheet.

The magnetic sheet 110 having such a configuration may be manufactured by preparing slurry containing the flake alloy powder 112 and the binder 114 in an organic solvent, and thereafter coating the slurry on a carrier film by a casting method such as a doctor blade method, and the like, and then carrying out drying and heat treatment at a temperature of 200° C. or less, and about 100° C.-200° C. to cure the binder 114. Herein, the organic solvent may be removed by volatilization before drying, and the carrier film may be removed after heat treatment.

Again, referring to FIGS. 2 through 5, the magnetic body 120 in which the plurality of magnetic sheets 110 containing the flake alloy powder 112 of which the major axis is arranged in parallel to an upper surface of the magnetic body 120 are stacked includes the coil 130 therein, and the magnetic body 120 and coil 130 are included as a main body.

As illustrated in FIGS. 4 and 5, the coil 130 includes a plurality of layers of vias 132, a plurality of wiring patterns 134 and 136, and two lead patterns 138.

In the middle layers of the plurality of magnetic sheets 110, the vias 132 are formed by penetrating the magnetic sheet 110 of each layer in a plurality of rows on one side and on the other side. A single layer of the vias 132 formed in the magnetic sheet 110 of each layer are stacked into a plurality of layers in the magnetic body 120, thereby forming a via laminate 133.

In FIG. 5, the via laminate 133 consisting of 5 rows and 3 layers on one side and the other side is illustrated as an example, however, in FIG. 2, the via laminate 133 is illustrated integrally without distinction of the layer.

These vias 132 are formed by filling the via hole 131 formed on the magnetic sheet 110 in each layer with a conductive material. In view of reducing thickness, the vias 132 may be formed of a plated layer in via holes 131 by a plating method.

For example, the vias 132 in each layer may be formed of a plated layer by punching or drilling a predetermined area to form vias of the magnetic sheet 110 in each layer to form a plurality of rows of the via holes 131 on one and the other sides, and plating the conductive material within the via holes 131 by a plating method to form a plated layer.

As illustrated in FIG. 4, on the outside of the magnetic sheet 110 in which the vias 132 are formed, the magnetic sheet 110 on which a plurality of first wiring patterns 134 are formed may be disposed on the upper layer, and the magnetic sheet 110 on which a plurality of second wiring patterns 136 and two lead patterns 138 are formed may be disposed on the lower layer.

The plurality of first wiring patterns 134 may be disposed at least in parallel in a stripe shape corresponding to the vias 132 in a top layer in each row.

Any one of the two lead patterns 138 corresponds to the via 132 in a bottom layer at an outermost area on one side to be extended to the external electrode 140 on one side, and the other one of the two lead patterns 138 corresponds to the via 132 in a bottom layer at an outermost area on the other side to be extended to the external electrode 140 on the other side. Both ends of the lead pattern 138 may be externally exposed from the magnetic body 120 at opposite end portions.

The plurality of second wiring patterns 136 may be disposed at least in parallel in a stripe shape in a diagonal direction corresponding to the vias 132 on one and the other sides in neighboring rows, except the vias 132 at the outermost areas on one and the other sides corresponding to the lead patterns 138. Herein, the second wiring patterns 136 may be formed on the same plane as the lead patterns 138 to further aim at reducing a thickness of the power inductor 100.

The first and second wiring patterns 134 and 136, the vias 132, and the lead patterns 138 provided in each magnetic sheet 110 are formed as one coil 130 within the magnetic body 120 by stacking the plurality of magnetic sheets 110.

That is, as illustrated in FIG. 5, the coil 130 is electrically interconnected by the first and second wiring patterns 134 and 136 in each layer, the plurality of layers of vias 132 electrically connecting the first and the second wiring patterns 134 and 136, and the lead patterns 138 connected to the vias 132 to be extended to the external electrode 140, thereby having a spiral shape wound at least one turn.

This spiral coil 130 is arranged in a direction parallel to the magnetic sheet 110 within the magnetic body 120 or the upper surface of the magnetic body 120, identically to the major axis of the flake alloy powder (see 112 of FIG. 3).

By this configuration, when current flows in the coil 130 in FIG. 5, a direction of the magnetic flux (or magnetic path) is generated in a direction parallel to the upper surface of the magnetic body 120 around the coil 130.

As a result, the direction of the magnetic flux generated in the coil 130 is parallel to the major axis direction of the flake alloy powder (see 112 in FIG. 3).

In this case, the magnetic path and the major axis direction of the flake alloy powder (see 112 in FIG. 3) are consistent with each other. Thus, when applying an external magnetic field, an effect of increasing the magnetic permeability may be expected as compared with a spherical or flake alloy powder (see 112 in FIG. 3) having no shape anisotropy, or unshaped powder having low shape anisotropy, by the magnetic characteristic due to shape anisotropy possessed by the flake alloy powder (see 112 in FIG. 3), and through which a high degree of inductance may be implemented.

The vias 132, the first and second wiring patterns 134 and 136, and the lead patterns 138 forming the coil 130 are conductive patterns generating a magnetic field by allowing current to flow when power is applied, and may be formed of materials having excellent electrical conductivity, for example, a metal selected from the group consisting of gold (Au), silver (Ag), platinum (Pt), copper (Cu), nickel (Ni), palladium (Pd), aluminum (Al), titanium (Ti), and the like, or alloys thereof, but any common conductive material may be employed without limitation.

The vias 132, the first and second wiring patterns 134 and 136, and the lead patterns 138 may be formed of the same materials for more stable electrical characteristics.

The plurality of first and second wiring patterns 134 and 136 and the two lead patterns 138 are formed by filling a plurality of holes (not shown) formed on the magnetic sheet 110 in each layer with conductive materials. In view of reducing thickness, at least any one of the first and the second wiring patterns 134 and 136 and the lead patterns 138 may be formed of a plated layer by a plating method, like the vias 132.

For example, the first and second wiring patterns 134 and 136 and the lead patterns 138 may be formed of a plated layer by punching or drilling a predetermined area to form the first and second wiring patterns 134 and 136 and the lead patterns 138 of the magnetic sheet 110 in each layer to form holes, and plating conductive materials within the holes by a plating method.

For convenience of description, the vias 132 consisting of 5 rows and 3 layers are illustrated in the exemplary embodiment. The vias are not limited thereto, however, and the number of rows and layers of the vias 132 may be variously changed in consideration of the characteristics of the inductor. Further, the position of the vias 132 and the like may be changed depending on the shape change of the first and second wiring patterns 134 and 136.

Further, as illustrated in FIGS. 2 and 4, the outermost layers, that is, the top layer and the bottom layer of the magnetic body 120 are provided with a magnetic sheet which does not include the pattern forming the coil 130.

The magnetic sheets on the top and bottom layers provided in the magnetic body 120 may substantially serve as a cover covering the coil 130.

When current flows in the coil 130, a magnetic path is also formed in the magnetic sheets on the outermost layers of the magnetic body 120. Thus, when the magnetic sheets on the outermost layers containing the flake alloy powder of which the major axis is arranged in a direction parallel to the upper surface of the magnetic body 120 are formed, magnetic flux leakage in a direction perpendicular to the major axis direction of the flake alloy powder is decreased, thereby implementing a high degree of inductance.

In addition, among the components of the power inductor 100, a pair of external electrodes 140 may be formed at opposite end portions of the magnetic body 120, as illustrated in FIGS. 1 and 2.

The external electrodes 140 may serve as external terminals electrically connecting the coil 130 and the external circuit by connection with the lead pattern 138, which may have both ends externally exposed from the magnetic body 120.

That is, as one end of the coil 130 is electrically connected to the external electrode 140 on a first side of the power inductor, and the other end of the coil 130 is electrically connected to the external electrode 140 on a second side of the power inductor, the coil 130 may be electrically connected to the external circuit via the pair of external electrodes 140.

As the external electrodes 140, any common conductive material may be employed without limitation, and for example, the external electrodes 140 may be formed of a metal selected from the group consisting of gold (Au), silver (Ag), platinum (Pt), copper (Cu), nickel (Ni), palladium (Pd), and the like, or alloys thereof.

The external electrodes 140 may be formed by plating the opposite end portions of the magnetic body 120 to be covered using a dipping manner and the like, and then performing sintering at a temperature of about 700° C. to 900° C.

As the major axis direction of the flake alloy power 112 and the direction of the magnetic flux generated in the coil 130 are consistent with each other, the thus-formed power inductor 100 may implement a high degree of inductance through increased magnetic permeability by utilizing the shape anisotropy of the flake alloy powder 112.

Further, the power inductor 100 of the exemplary embodiment has a high saturation magnetization value (Ms) like the flake alloy powder, includes magnetic metal powder having a small decrease in inductance depending on DC-bias, and utilizes the shape anisotropy possessed by the flake alloy powder, thereby being usable in a high frequency band at 1 MHz or more, and at a high current.

Moreover, since at least any one of the vias 132, the wiring patterns 134 and 136, and the lead patterns 138 forming the coil 130 in the power inductor 100 of the exemplary embodiment is formed of a plated layer, the power inductor may be thinned.

As such, according to the exemplary embodiment, an inductance implementation problem when implementing a next-generation inductor having a smaller size than the existing inductor models may be improved through implementing high magnetic permeability utilizing the shape anisotropy of powder. Thus, a DC-bias property by decreasing the size of magnetic bodies within the inductor due to a smaller element body size may be improved.

Accordingly, the power inductor 100 of the exemplary embodiment is appropriate for use in a high-performance electronic device such as a smart phone, a tablet PC, and the like requiring higher frequency, higher current, higher inductance, thinning and the like.

Meanwhile, FIG. 6 is a cross-sectional view of a power inductor according to another exemplary embodiment in the present disclosure.

In the exemplary embodiment in FIG. 6, the same reference numerals are assigned for the same components as in the exemplary embodiment in FIG. 2 as previously described, and only the differences will be described while omitting overlapping description for the same components.

The configuration of the exemplary embodiment in FIG. 6 is the same as that in FIG. 2, except that the powder contained in the magnetic sheet 110 is a spherical alloy powder 112a having no shape anisotropy.

When the horizontal structure using the plurality of layers of vias 132 illustrated in FIG. 5 is applied to the inside of the magnetic body 120 using the spherical alloy powder 112a, the cross-sectional area of the coil 130 to be formed may be freely increased only by adjusting the size of the via hole 131 formed on each magnetic sheet 110. Thus, the overall efficiency of the inductor may be expected to be improved by reducing Rdc, resistance of the coil 130, through which low current driving is possible.

When forming the existing coil pattern through plating by the existing manner, for reducing Rdc of the coil, it is the only way to increase the aspect ratio of the coil (the ratio of horizontal to vertical, assuming that the cross-section of the coil to be formed is rectangular) formed by plating to increase the cross-sectional area; however, in this case, it is known that implementation at about 3 to 5:1 is a technical limitation.

Differently from the illustration in the drawing, however, in the exemplary embodiment in FIG. 6, the magnetic sheets on the top and bottom layers 137 for coverage provided in the magnetic body 120 contain the flake alloy powder of which the major axis is arranged in a direction parallel to the upper surface of the magnetic body 120, as illustrated in FIG. 2, and thus a high degree of inductance may be implemented due to reduction of the magnetic flux leakage, as in the exemplary embodiment of FIG. 2.

As set forth above, the power inductor according to the present exemplary embodiment may be used in a high frequency band and at a high current through improved magnetic permeability utilizing the shape anisotropy of an alloy powder, and may implement a high degree of inductance.

Further, the power inductor according to the exemplary embodiment may be used in a high frequency band and high current through introduction of a coil in a horizontal structure using a plurality of layers of vias within a magnetic body, and may be capable of low current driving due to Rdc reduction.

While exemplary embodiments have been shown and described above, it will be apparent to those skilled in the art that modifications and variations could be made without departing from the scope of the present invention as defined by the appended claims.

What is claimed is:

1. A power inductor comprising:
a magnetic body;
a coil provided in the magnetic body; and
external electrodes disposed on the magnetic body,
wherein the magnetic body comprises a stacked plurality of magnetic sheets including a flake alloy powder, and
a major axis of the flake alloy powder and a major axis of the coil are arranged in a direction parallel to an upper surface of the magnetic body.

2. The power inductor of claim 1, wherein the major axis of the flake alloy powder is parallel to a direction of a magnetic flux generated in the coil.

3. The power inductor of claim 1, wherein the coil includes:
a first wiring pattern formed in an upper magnetic sheet among the plurality of magnetic sheets,
a second wiring pattern formed in a lower magnetic sheet among the plurality of magnetic sheets,
a plurality of layers of vias formed in a plurality of magnetic sheets among the plurality of magnetic sheets, and electrically connecting the first and second wiring patterns, and
lead patterns formed in the lower magnetic sheet, and connected to the external electrodes.

4. The power inductor of claim 3, wherein the lead patterns are formed on a same plane as the second wiring pattern.

5. The power inductor of claim 3, wherein at least any one of the vias, the first and second wiring patterns, and the lead patterns include a plated layer.

6. The power inductor of claim 1, wherein the flake alloy powder includes iron (Fe).

7. The power inductor of claim 6, wherein the flake alloy powder is one or more selected from the group consisting of an Fe—Si-based alloy, sendust (Fe—Si—Al), permalloy (Fe—Ni), an Fe—Si—Cr-based alloy, and an Fe—Si—B—Cr-based amorphous alloy.

8. The power inductor of claim 1, wherein the magnetic sheet has a thickness of 30 μm to 90 μm.

9. The power inductor of claim 1, wherein the magnetic body includes an outer magnetic sheet provided on an outermost layer, the outer magnetic sheet covering the coil and having no pattern.

10. The power inductor of claim 1, wherein the magnetic sheet includes a binder.

11. The power inductor of claim 1, wherein the external electrodes are formed at opposite end portions of the magnetic body.

12. A power inductor comprising:
a magnetic body comprising a stacked plurality of magnetic sheets;
a coil provided in the magnetic body; and
external electrodes disposed on the magnetic body,
wherein the coil includes a plurality of layers of vias, the plurality of layers of vias comprising vias formed in each magnetic sheet into a plurality of layers.

13. The power inductor of claim 12, wherein the coil includes:
a first wiring pattern formed in an upper magnetic sheet among the plurality of magnetic sheets,
a second wiring pattern formed in a lower magnetic sheet among the plurality of magnetic sheets,
a plurality of layers of vias formed in a plurality of magnetic sheets among the plurality of magnetic sheets, and electrically connecting the first and second wiring patterns, and
lead patterns formed in the lower magnetic sheet, and connected to the external electrodes.

14. The power inductor of claim 12, wherein the vias include a plated layer.

15. A power inductor comprising:
a magnetic body;
a coil provided in the magnetic body; and
external electrodes disposed on the magnetic body,
wherein the magnetic body comprises a stacked plurality of magnetic sheets, and
uppermost and lowermost magnetic sheets among the plurality of magnetic sheets include a flake alloy powder, and a major axis of the flake alloy powder and a major axis of the coil are arranged in a direction parallel to an upper surface of the magnetic body.
